(19) United States
(12) Patent Application Publication
(10) Pub. No.: US 2015/0339743 A1
(43) Pub. Date: Nov. 26, 2015

(54) SYSTEM FOR RELATIONSHIP-BASED SYSTEM FOR FACILITATING TRANSACTIONS

(71) Applicant: Swampum LLC, Wilmette, IL (US)

(72) Inventors: Jeff Johnston-Legg, Wilmette, IL (US); Pou-Chang (aka John) Chen, Chicago, IL (US)

(21) Appl. No.: 14/550,785

(22) Filed: Nov. 21, 2014

Related U.S. Application Data
(60) Provisional application No. 62/002,660, filed on May 23, 2014.

(51) Int. Cl. G06Q 30/06

(52) U.S. Cl. CPC G06Q 30/0611

(57) ABSTRACT

A method and system for a Posting User to communicate a Transaction Proposal to potential Viewing Users in relation to an Item includes creating an Availability Schedule which contains at least one Rank including a Relationship Credential and a Reserve Value; creating a Transaction Proposal; assigning the Availability Schedule to the Transaction Proposal; and submitting the Transaction Proposal to an Inventory Database in which the a Transaction Proposal is assigned a posting date and becomes a Posted Transaction Proposal. The Inventory Database is searchable by potential Viewing Users having a Relationship Credential that is in the Availability Schedule.

### RELATED APPLICATIONS

This application claims the benefit of U.S. Provisional Patent Application No. 62/002,660 filed on May 23, 2014, the contents of which are incorporated herein by reference in their entirety.

### FIELD OF THE INVENTION

The present invention relates generally to a system and method of for facilitating transactions.

### BACKGROUND

People have been giving and sharing items with those around them probably for as long as humans have existed, and most people direct their sharing to those they favor most or who they feel will most appreciate the shared item, often offering things first to family, then friends, and then to their other social groups.

For example, a woman with a young child may have clothing that her child has outgrown but is still in good condition. She would most likely offer it to someone close to her (a family member or close friend) who also has a young child.

Similarly, a person may have a collection of books, DVDs, CDs and tools that he is willing to share with people he knows and trusts, but not with the general public.

Recently, web sites have arisen that allow people to discard unwanted items and obtain wanted items, though all follow a simplistic approach that only allows users to post offered or requested items on a “one to everyone” basis. This limited approach does not allow a person to limit the availability of his items to certain people or groups or to control the timing or pricing of that availability to different people.

There is a need for a system that would allow users not only to add offered or requested items, but to control the availability of those items to a prioritized and scheduled list, and to customize those prioritized schedules across different types of items.

### Related Art

U.S. Pat. No. 8,463,817 to Chow et al., dated Jun. 11, 2013, discloses a system and method for creating and classifying listings within user-defined marketplaces. However, Chow et al. do not disclose the creation of Availability Schedule that can be designed and stored by a user for future use.

### SUMMARY OF THE INVENTION

According to one aspect, the present invention provides a method for a Posting User to communicate a Transaction Proposal to potential Viewing Users in relation to an Item. The method comprises creating an Availability Schedule comprising at least one Rank including a Relationship Credential and a Reserve Value; creating a Transaction Proposal; assigning the Availability Schedule to the Transaction Proposal; and submitting the Transaction Proposal to an Inventory Database in which the a Transaction Proposal is assigned a posting date and becomes a Posted Transaction Proposal, the Inventory Database being searchable by potential Viewing Users having a Relationship Credential that is in the Availability Schedule.

According to another aspect, there is provided a method to facilitate transactions between a Posting User and plurality of Viewing Users, comprising storing a Posting User's first Availability Schedule. The Availability Schedule comprises at least two ordered Ranks including a last Rank and at least one ante-ultimate Rank, wherein at least the ante-ultimate Rank which includes a Relationship Credential and an associated Availability Attribute. A Transaction Proposal associated with the first Availability Schedule is received from the Posting User. A Posted Transaction Proposal comprising the Transaction Proposal and its association with the Availability Schedule is added to an Inventory Database. Then, a Search Query is received from a Viewing User. The method includes searching the Inventory Database for Posted Transaction Proposals having a Posting Attribute that corresponds to the Search Query and to which the Viewing User is permitted access according to the Availability Schedule (“Available Postings”); displaying the Available Postings to the Viewing User; and enabling the Viewing User to communicate with the Posting User regarding each Available Posting.

According to yet another aspect, the invention provides a system for facilitating transactions between Posting Users and Viewing Users. The system comprises first means, for creating at least one Availability Schedule having at least one Rank including a Relationship Credential and a Reserve Value; second means, for creating a Transaction Proposal; third means, for assigning the Availability Schedule to the Transaction Proposal; and fourth means, for submitting the Transaction Proposal to an Inventory Database in which the a Transaction Proposal is assigned a posting date and becomes a Posted Transaction Proposal, wherein the Inventory Database is searchable by potential Viewing Users having a Relationship Credential that is in the Availability Schedule.

In still another aspect, the invention provides a system for facilitating transactions between Posting Users and Viewing Users, comprising first means, for storing a Posting User's first Availability Schedule, the Availability Schedule comprising at least two ordered Ranks including a last Rank and at least one ante-ultimate Rank, wherein at least the ante-ultimate Rank includes a Relationship Credential and an associated Availability Attribute; second means, for receiving from the Posting User a Transaction Proposal associated with the first Availability Schedule; third means, for adding to an Inventory Database a first Posted Transaction Proposal comprising the first Transaction Proposal and its association with the first Availability Schedule; receiving a first Search Query from a Viewing User; fourth means, for searching the Inventory Database for Posted Transaction Proposals having a Posting Attribute that corresponds to the Search Query and to which the Viewing User is permitted access according to the Availability Schedule (“Available Postings”); fifth means, for displaying the Available Postings to the Viewing User; and sixth means for enabling the Viewing User to communicate with the Posting User regarding each Available Posting.

These and other features of the present invention are further described in drawings described below and in the Detailed Description which follows.

### BRIEF DESCRIPTIONS OF THE DRAWINGS

FIG. 1 is a schematic block diagram of a system according to one embodiment of the invention.

FIG. 2 is a schematic block diagram of an Availability Schedule module according to one embodiment of the invention.

FIG. 3 is a schematic block diagram of an Item Entry Module according to one embodiment of the invention.

FIG. 4A is a schematic block diagram of a Search and Filter Module according to one embodiment of the invention.

FIG. 4B is a schematic block diagram of a portion of FIG. 4A.

FIG. 4C is a schematic block diagram of another portion of FIG. 4A.

FIG. 4C is a schematic block diagram of still another portion of FIG. 4A.

FIG. 4D is a schematic block diagram of yet another portion of FIG. 4A.

### DETAILED DESCRIPTION

Various aspects of this invention provide methods and systems by which a user can convey a proposed transaction concerning things that the user wishes to exchange, whether they be tangible (a new or used product, e.g., a musical instrument) or intangible (e.g., a service or a digital media file (graphic, music, video, a program, message, etc.), generically referred to herein as “Items.” The proposed transaction may be one in which the user offers the Item to others (e.g., the user is seeking to sell, rent, lend or perform the Item) or in which the user proposes to receive the Item (e.g., the user is seeking to buy, borrow or receive an Item), under a variety of terms or conditions. For purposes of describing the method and system, the user who proposes a transaction is referred to herein as a “Posting User,” and each user who may seek out a Posting User's proposal to possibly review and accept it, is referred to herein as a “Viewing User.” The transaction proposal and the ability to reply to the Posting User or accept the transaction proposal is made available to other users in a pre-determined sequence. The methods and systems of this invention may be embodied and carried out electronically by users with common access to one or more computers programmed to perform the functions needed to implement the method. In a preferred embodiment, a server is programmed to provide the functions and is accessible to users over a network such as the internet.

In one embodiment, a Posting User can place a transaction proposal into a searchable database, referred to herein as an “Inventory Database,” in which the Posting User's proposal is assigned a posting date and is referred to as a Posted Transaction Proposal. The Posted Transaction Proposal, and the ability to reply to the Posting User or accept the transaction proposal, is made available to Viewing Users according to a schedule which is associated with the Posted Transaction Proposal in the Inventory Database. The schedule is referred to herein as an “Availability Schedule.”

A Viewing User may have a Relationship Credential which signifies a relationship that the Viewing User has with the Posting User. The Relationship Credential may indicate membership in a Group in common with the another user, either by default (as described elsewhere herein) or as a result of the Viewing User optionally joining a Group in common with a Posting User, or the fact that the Viewing User accepted an invitation to enter into a “Friendship” relationship with the Posting User. Relationship Credentials are obtained by forming a group, joining a group or accepting a friendship. However, the invention is not limited in this regard and in other embodiments, there may be additional Relationship Credentials as well. In one embodiment, the system stores a Viewing User's Relationship Credentials by including the Viewing User's userID in a table which lists members in Groups or in a table of another user's Friendships.

An Availability Schedule includes a least one Relationship Credential assigned to a rank (“Rank”), and the system uses Ranks to sequence and time the availability of a Posted Transaction Proposal to Viewing Users having Relationship Credentials listed in the Availability Schedule. The Rank is simply an ordinal indicator (1st, 2nd, etc., or the like) which indicate the relative sequence of availability as determined by a Reserve Period assigned to that Rank, as described further elsewhere herein. For ease of expression, a Rank is sometimes said to ‘contain’ one or more Relationship Credentials, and a Viewing User having a Relationship Credential in a particular Rank is said to “be in” that Rank; so, it may be said of a Viewing User having a Relationship Credential in the 2nd Rank of an Availability Schedule that the Viewing User is in the 2nd Rank. Viewing Users in a 1st Rank have immediate access to a Posted Transaction Proposal.

In one embodiment, the system creates for each registered user a Relationship Credentials list to record the Groups, Friendships, and optionally other relationships that the user is a member of, has entered into, or has formed.

In one embodiment a default Relationship Credential List and default Availability Schedule is created for the new user when the user registers as a prerequisite using the system to respond to post, view and respond to Posted Transaction Proposals. The user would be required to register in the system to be able to post, view and respond to Posted Transaction Proposals, and the registered user is initially assigned, by default, as a member of two groups. A first default group includes all users in a common ZIP code (a “ZIP Code Group”). For example, by entering ZIP code 60091 in his registration form, the user becomes a member of the 60091 (Wilmette, Ill.) ZIP Code Group, which may provide a Relationship Credential of “ZIP Code Group 60091”. A second default group includes all registered users (the “Public Pool” Group), which may provide a Relationship Credential of “Public Pool”. In addition, corresponding default Relationship Credentials are created for the newly registered user, and a default Availability Schedule is created for the user. The default Availability Schedule has two Ranks and includes the user's ZIP Code Group in the 1st Rank and the Public Pool group Relationship Credential in a 2nd (last) Rank.

Any Rank that precedes the last (or “ultimate”) Rank may sometimes be referred to herein as an “ante-ultimate” Rank. In one embodiment, each ante-ultimate Rank has a “Reserve Period” (e.g., a number of days) during which Viewing Users in that Rank are permitted access to, and the ability to respond to (e.g., accept) a Posted Transaction Proposal before Viewing Users in the next Rank are permitted to do so. The Reserve Period of a Rank is measured from the end of the Reserve Period of the preceding Rank, if there is one; otherwise from the posting date of the Posted Transaction. The Reserve Period is an attribute of the Rank. In the default example just described, the ZIP Code Group will be given access to a Posted Transaction Proposal associated with the default Availability Schedule before the Public Pool.

Referring now to the Figures, selected embodiments of the invention will be described in greater detail.

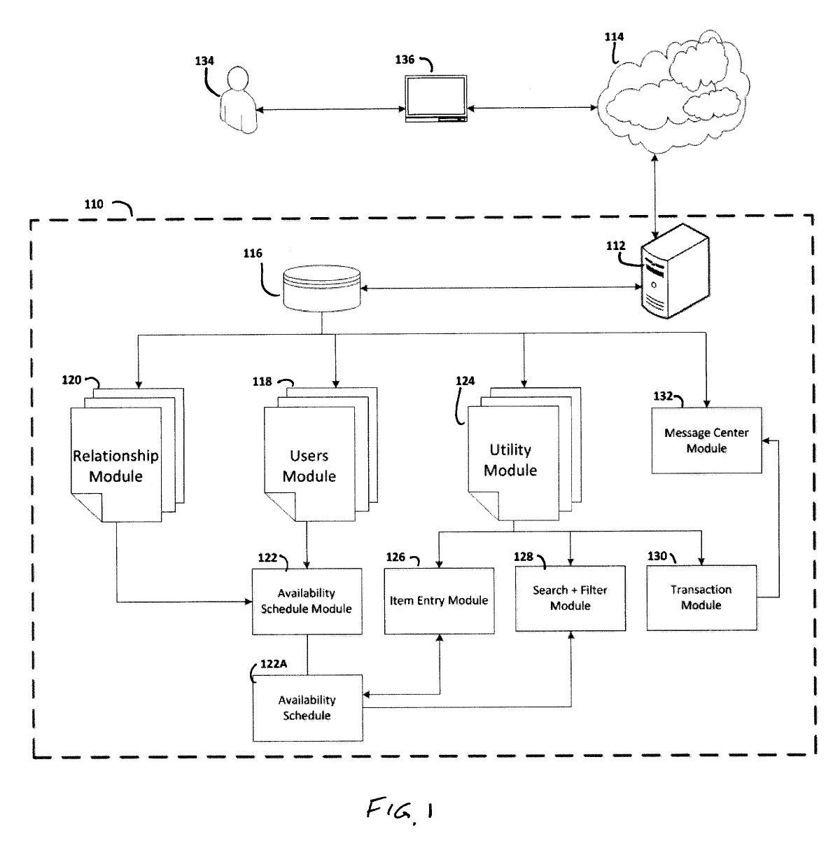

There is represented in FIG. 1 a system according to the present invention. The system 110 includes a computer network server 112 which is accessible by users over a network 114 such as the internet and which is programmed to carry out functions necessary for the practice of the invention. The server hosts a System Database 116 which is a database with tables and process (modules) for maintaining and processing data relations to groups, users, and Items, including: a Users Module 118, a Relationship Module 120, an Availability Schedule Module 122, and an Item Utility Module 124 which includes an Item Entry Module 126, a Search and Filter Module 128, a Transaction Module 130 and a Message Center Module 132. The System Database 116 also includes the Inventory Database described herein. A user 134 uses a personal computer 136 which is configured with a network browser to access the network 114 to reach the server 112 in order to use the system 110.

The Users Module 118 includes a registration routine which requires and permits a user to create an account and become a registered user to be permitted to employ the various modules of the system to establish relationships with other users, by forming or joining Groups and Friendships and inviting other users to participate in transactions. The Users Module 118 generates login credentials for the user and a userID for use by the system, and optionally stores other data associated with the user (e.g., the ZIP Code of the user's residence) for other system functions. The Users Module 118 may also store user data for generating a user page in the system for other users to see, optionally including a browse-able inventory of the user's Posted Transaction Proposals.

The Relationship Module 120 enables a registered user to create a new Group in the Database 116. The Group creator is automatically listed as a member of the Group. The new Group may be a Public Group, a Private Group or a Hidden Group. As described further below, the System 110 includes a search function and the database 116 is searchable for Public Groups by registered users, and the Relationship Module 120 is configured to enable a registered user to join (i.e., become a member of) any Public Group. For Private Groups and Hidden Groups, the creator of the group is also designated the group moderator, who has authority to determine membership in the group. If the registered user finds a group of interest that the creator has made a Private Group, the Relationship Module 120 is configured to allow the registered user to send a request for membership to the group creator, and if the group creator accepts the request, the registered user is added to the Group's membership list. The system may allow the group creator to appoint a moderator who has the authority to accept members into the group and change other aspects of the group that the system may provide. Optionally, the system will name the group creator as the moderator, by default. Hidden Groups are not available to searchers of the system and can be joined by invitation only. Membership in a Group is one kind of relationship that can be used in an Availability Schedule as described further herein. The Relationship Module 120 also enables the registered user to invite other users to accept a Friendship relationship with the registered user. If accepted, the Friendship can be used in an Availability Schedule in the same way as a Group. The Relationship Module 120 includes a database of all relationships of each user and includes the name of each Group and a user membership list for each Group.

In one embodiment, there is a database table in the system for friendships and a table for Group memberships. In another embodiment, there is a single database table which lists both friendships and memberships for all users and which includes a relationshipType field (which indicates whether the relationship is a friendship or membership). Each table consists of an ID field, a userID field (to indicate to which user the friendship/membership relates), a relationshipID field (which includes the friend's userID for friendships or the group's groupID for memberships), and additional fields detailing date joined, date suspended, date closed, etc., and whether the relationship is ‘active’ or ‘on hold’. A person having an ‘active’ status will have access to all Posted Transaction Proposals that are available based on that relationship; a member whose relationship is ‘on hold’ will remain in the relationship but will not have access to the Posted Transaction Proposals available based on that relationship until the member becomes active again. The system is configured to permit either the group moderator to change a member's status from ‘active’ to ‘on hold’ and back, or, optionally, to allow the member to make that change for himself. Such changes may be useful for times when a friend or group member is going to log out from the system for an extended period of time, e.g., due to taking a vacation, and so will not be available to participate in group activities or to engage in transactions.

In one embodiment the Item Utility Module 124 is configured to serve three functions: (i) it includes an Item Entry Module 126 to enable a user to enter Posted Transaction Proposals into the Database 116 for review by other users; (ii) it includes a Search Filtering System Module 108 to allow other users to search for and find Posted Transaction Proposals, and (iii) it includes a Transaction System Module 107 to enable users to conduct the transaction proposed in Posted Transaction Proposals.

The Item Entry Module 126 enables a registered user to post a transaction proposal to the Inventory Database as a Posted Transaction Proposal having an associated Availability Schedule 122A. The Posted Transaction Proposal includes fields for Item Attributes which identify (i) the Posting User, (ii) the Item, (iii) the transaction proposed by the Posting User for that Item (e.g., lend or borrow, sell or buy, share, etc.), (iv) optionally other data such as the Posting User's userID, and (v) the Availability Schedule 122A associated with that Posted Transaction Proposal. The Item Entry Module 126 also adds (v) a posting date to the Posted Transaction Proposal when the Posted Transaction Proposal is available for searching by Viewing Users. The Item Attributes, together with the posting date and any other data added by the system to the Posted Transaction Proposal, are the “Posting Attributes.” All Posted Transaction Proposals entered by a Posting User are referred to herein as the Posting User's “inventory.”

As mentioned above, the Availability Schedule Module 122 enables the registered user to generate an Availability Schedule 122A for use in prioritizing access by other users to Posted Transaction Proposals created by the user. In one embodiment, the Availability Schedule Module 122 generates a default Availability Schedule 122A for a registered user automatically, optionally upon registration.

The system default Availability Schedule 122A may be based on information provided by the registered user upon registration. For example, if the registration process requires the user to provide a ZIP Code of the user's residence, a system default Availability Schedule 122A may be based on giving first access to the registered user's inventory to Viewing Users who reside in areas in, and optionally adjacent to, the Posting User's ZIP Code, as represented in Table 1.

TABLE 1
DEFAULT AVAILABILITY SCHEDULE

| | |
|---|---|
| Ranks | Rank Attributes |

| | | |
|---|---|---|
| Rank #1 | Relationships = | Reserve Period = |
| | ZIP Code Group | 7 Days |
| Last RANK | RELATIONSHIPS = | — |
| (2nd) | Public Pool | |

— indicates that no Reserve Attribute is applied, e.g., there is no Reserve Period or other Rank Attribute for the last Rank. (Since there is no one to grant access to after the Public Pool, it would not make sense to provide a Reserve Period to the last Rank.

The Default Availability Schedule of Table 1 has two Ranks, a first Rank and a last (second) Rank, with each Rank containing a Relationship Credential for a Group to which the user belongs by default. The first Rank contains the ZIP Code Group, while the last Rank contains the Public Pool Group. In addition, the first Rank has another Rank Attribute: a Reserve Period of 7 days. However, the invention is not limited in this regard and in various alternative embodiments, a default Availability Schedule may simply contains one Rank to make a Posted Transaction Proposal available to the Public Pool or, alternatively, only to Viewing Users having a Relationship Credential in addition to the Public Pool (e.g., only to the user's ZIP Code Group) so that the Public Pool is never granted access. In still other embodiments, the system may make a Posted Transaction Proposal available to the Public Pool automatically, after the reserve period for each Rank in the applicable Availability Schedule has been applied. In such an embodiment, it would make sense to provide a Reserve Period even for the last Rank.

### Creating and Modifying Additional Availability Schedules

An optional feature of the invention provides that in addition to this default Availability Schedule, a user can create and save for future use one or more custom (i.e., non-default) Availability Schedules. In one embodiment, a custom Availability Schedule can be created by copying an existing Availability Schedule, assigning it a new name, and then modifying it by rearranging Ranks and Attributes (as described above) or by adding and/or deleting Relationship Credentials. For example, the user could create a new Availability Schedule (to be used just for lending books to his friends) by copying his default schedule, naming it “Book Lending Schedule,” deleting the default ZIP Code Group and the Public Pool. This would leave only his “My friends” Relationship Credential in the Book Lending Schedule, and only Viewing Users who have entered into friendship with the Posting User would be able to see what books he has available to lend when the Book Lending Schedule is associated with a Posted Transaction Proposal for lending his books. The Ranks and Relationship Credentials of Availability Schedules can be modified at any time as described above for the default Availability Schedule.

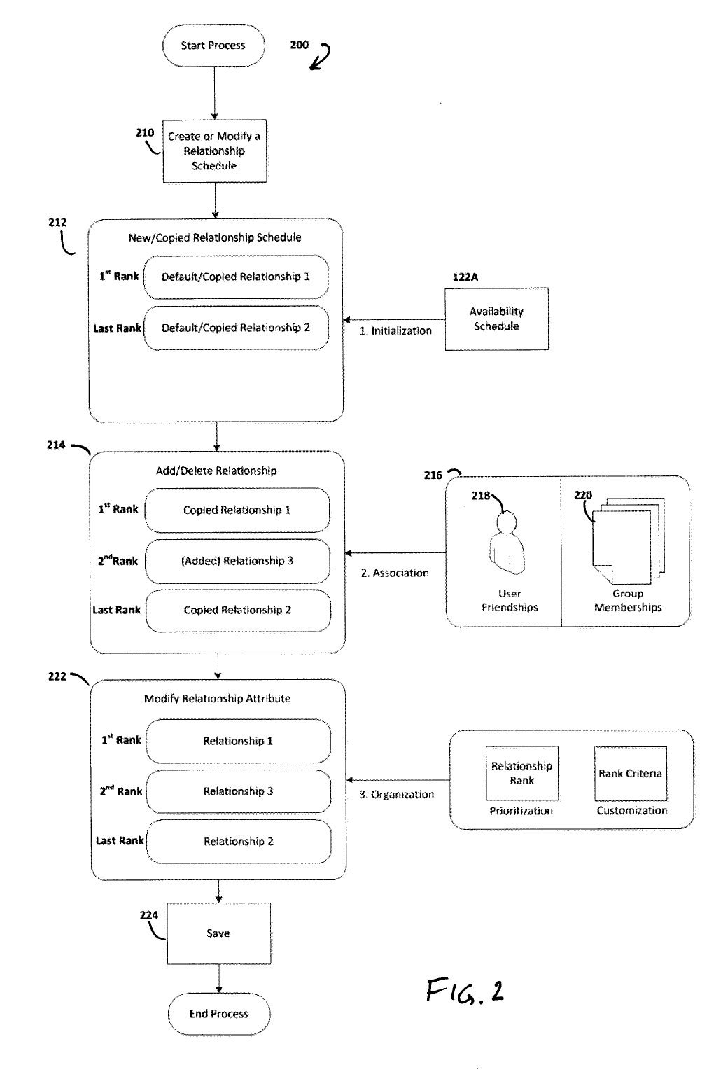

For example, referring now to FIG. 2, the Availability Schedule Module 122 includes a routine 200 which allows the registered user 132 to define a custom (i.e., non-default) Availability Schedule. In Step 210 of routine 200 the user 134 selects “Create a New Availability Schedule.” A template custom Availability Schedule 212 is then created by duplicating the default Availability Schedule 122A. At this stage, the template customer Availability Schedule 212 has a first Rank (Rank 1) and a Last Rank containing, respectively, Relationship 1 and Relationship 2. In Step 214, the user 134 adds a Relationship Credential from his Relationship Credential list 216, which lists the user's friendships 218 and Group memberships 220, to the Availability Schedule. The system may display a visual representation of the template Availability Schedule with Ranks arranged vertically, and a display of the Relationship Credentials in each Rank, and the system may be configured to enable the user to select a Relationship Credential not yet in the Availability Schedule and add it to the desired Rank. Likewise, the user might select a Relationship Credential that is already in a Rank and move it to a different Rank or delete it from the Availability Schedule. Optionally the system is configured to enable the user to add a new Rank to an Availability Schedule or to delete an unwanted Rank. In one embodiment, before an Availability Schedule is saved for future use, Ranks that do not contain any Relationship Credentials are deleted. When a new Rank is positioned in the Availability Schedule, or a Rank is deleted, the Ranks are renumbered.

In step 222 the user assigns a rank to the added Relationship. In this example, the rank is ‘2^{nd}’, just above the last Rank, and the user also adds Rank Attributes such as a Reserve Period to the new Rank. Optionally, the user may add other Rank Attributes such as a price discount to be extended to Viewing Users in that Rank. The steps of adding, moving or removing a Relationship Credential, and optionally, adding a new Rank, may occur in any order. The Availability Schedule Module 122 may also enable the user to modify or add Rank Attributes for the Ranks already in the template. For example, there may be a provision for increasing or decreasing the Reserve Period, optionally including an Item Attribute Adjustment factor so that Viewing Users in that Rank see a different Item Attribute from what other Ranks see. One example Item Attribute Adjustment Factor is a Pricing Factor, for modifying the price assigned to a Posted Transaction Proposal. In one embodiment the Pricing Factor is used to apply a discount to the price, for the benefit of Viewing Users in that Rank. Another possible Rank Attribute is a deposit requirement required of a Viewing User as a condition of agreeing to the transaction. Optionally, the system may have a menu of Rank Attributes that a Posting User may choose from to assign to a Rank. Once the custom Availability Schedule is complete, the user saves it for future use, in step 224.

When a Posting User posts a Posted Transaction Proposal, the associated Availability Schedule is used to add data to a table which details the item# and the date the Posted Transaction Proposal will be available to each user having a relationship in the Availability Schedule (using userID and groupID). When a Viewing User looks at a Posting User's inventory or a Group's available items, this table is queried to determine which Posted Transaction Proposals are available to the Viewing User based on his friendships and Group memberships, i.e., to identify “Available Postings”.

In an illustrative embodiment that a registered user might employ to offer used sports equipment (a “Sports Stuff Availability Schedule”), the Availability Schedule includes three Relationship Credentials. The first Relationship Credential 203a is “Family,” the second Relationship Credential 203b is “Friends” and the third Relationship Credential 203c is a Group called “My Church.” In the Sports Stuff Availability Schedule, the Family Relationship Credential and the Friends Relationship Credential are both assigned Rank 1, and My Church is assigned Rank 2. In this way, the registered user's Contacts who have Family and Friend relationships with the Posting User will all be in Rank 1, and members of the Church Group will be in Rank 2.

In another optional embodiment, the Rank Attributes may include a price adjustment or a payment condition, so that when a Viewing User in that Rank has access to the Posted Transaction Proposal, that Viewing User may see a different price than users in other Ranks. For example, a price adjustment may be a discount applied to the price stated in the Posted Transaction Proposal. In a specific example, an Availability Schedule may indicate that Viewing Users in the first Rank will be granted a 10% discount price adjustment, while Viewing Users in a Second Rank receive only a 5% discount.

In another optional embodiment of the invention, a user may modify a default Availability Schedule in the same way as just described for custom Availability Schedules. For example, a user may modify the default Availability Schedule of Table 1 by changing the Reserve Period for Rank 1, changing the Relationship Credentials in Rank 1, adding a Rank and populating the new Rank with a Relationship Credential and Rank Attributes, moving Relationship Credentials from one Rank to another, and adding or removing Rank Attributes in any of the Ranks. In a specific example, the user modifies the default Availability Schedule of Table 1 to the form indicated in Table 2.

TABLE 2
First Modified Default Availability Schedule

| RANK | RANK ATTRIBUTES | | |
|---|---|---|---|
| RANK #1 | RELATIONSHIP Credential = | Reserve | Price |
| | ZIP Code Group | Period = | Adjustment = |
| | My Bowling Team | 10 days | 10% discount |
| | My Office Colleagues | | |
| | My Church Group | | |
| Last | Public Pool | — | — |
| RANK | | | |
| (2nd) | | | |

— indicates that no Reserve Attribute is applied, e.g., there is no Reserve Period or other Rank Attribute for the last Rank.

Table 2 shows that the user added three Relationship Credentials to Rank 1 alongside the ZIP Code Group: his “My Bowling Team;” “My Office Colleagues” and “My Church Group.” As a result, the other system users in these added Groups would have access to a Posted Transaction Proposal associated with this Availability Schedule together with users in his ZIP Code Group. He also increased the Reserve Period for Rank 1, and added a new Rank Attribute, the 10% price adjustment, which will apply now to all users with Relationship Credentials in Rank 1.

In another specific example, the user modified the default Availability Schedule of Table 2 to the form shown in Table 3A.

TABLE 3A
Modified Default Availability Schedule

| RANKS | RANK ATTRIBUTES | | |
|---|---|---|---|
| RANK #1 | RELATIONSHIP Credential = | Reserve Period = | Price Adjustment = |
| | My Church Group | 10 days | 10% discount |
| RANK #2 | RELATIONSHIP Credential = | Reserve Period = | Price Adjustment = |
| | My Bowling Team | 10 days | 10% discount |
| | My Office Colleagues | | |
| RANK #3 | RELATIONSHIP Credential = | Reserve Period = | Price Adjustment = |
| | ZIP Code Group | 10 days | 10% discount |
| Last | Public Pool | — | — |
| RANK (#4) | | | |

— indicates that no Reserve Attribute is applied, e.g., there is no Reserve Period or other Rank Attribute for the last Rank.

Table 3 shows that the user added a new first Rank for a New Relationship Credential above the previous Rank 1, and populating the new first Rank with My Church Group by moving My Church Group up from what eventually became Rank 3, and created another new Rank into which he moved My Office Colleagues Relationship and My Bowling Team. As suggested by Table 3, one optional feature of the invention is that when a Relationship Credential is moved from one Rank having one or more Rank Attributes into a new Rank that does not have corresponding Rank Attributes, the Rank Attributes from the original Rank are added to the new Rank by default. In this case, Rank 1 had no Rank Attributes of its own and so was given the Rank Attributes as Rank 3 (Reserve Period and Price Adjustment) when the user moved My Church Group into the new Rank 1. However, other Relationship Credentials moved into or added to the new Rank will not over-ride the Relationship Attributes already in that Rank, so that if the user had changed the Reserve Period for Rank 2 to 14 days just after moving the first Relationship Credential (e.g., My Office Colleagues) into that Rank, the 14 day Reserve Period would not be affected by the Reserve Period of Rank 3 when My Bowling Team was moved into that Rank from Rank 3.

In this example, the user further modifies the Availability Schedule of Table 3A as reflected by Table 3B.

TABLE 3B
Modified Default Availability Schedule

| RANKS | RANK ATTRIBUTES | | |
|---|---|---|---|
| RANK #1 | RELATIONSHIP Credential = | Reserve Period = | Price Adjustment = |
| | My Church Group | 14 days | 10% discount |
| RANK #2 | RELATIONSHIP Credential = | Reserve Period = | — |
| | My Bowling Team | 10 days | |
| | My Office Colleagues | | |
| RANK #3 | RELATIONSHIP Credential = | Reserve Period = | — |
| | ZIP Code Group | 10 days | |
| Last RANK | Public Pool | — | — |
| (#4) | | | |

— indicates that no Reserve Attribute is applied, e.g., there is no Reserve Period or other Rank Attribute for the last Rank.

Table 3B shows that the user increased the Reserve Period for Rank 1 and removed the Price Adjustment from Ranks 2 and 3.

In yet another specific example, the user further modifies the Availability Schedule of Table 3B to generate the modified default Availability Schedule of Table 4.

TABLE 4

TABLE 4
Third Modified Default Availability Schedule

| RANK | RANK ATTRIBUTES | | | |
|---|---|---|---|---|
| RANK #1 | RELATIONSHIP Credential = | Reserve | Price Adjustment = | [Add new] |
| | My Bowling Team | Period = | 10% discount | |
| | My Church Group | 14 days | | |
| RANK #2 | RELATIONSHIP Credential = | Reserve | Price Adjustment = | — |
| | My Office Colleagues | Period = | 10% discount | |
| | ZIP Code Group | 10 days | | |
| Last RANK | Public Pool | — | — | — |

— indicates that no Reserve Attribute is applied, e.g., there is no Reserve Period or other Rank Attribute for the last Rank.

Table 4 shows that the user moved My Bowling Team into Rank 1 alongside My Church Group and moved My Office Colleagues into Rank 3 of Table 3B alongside the ZIP Code Group. My Bowling Team will adopt the Rank Attributes of Rank 1. The empty Rank of Table 3B was deleted and the remaining Ranks were renumbered. My Office Colleagues will revert to the Reserve Period assigned to the ZIP Code Group but will carry with it the Price Adjustment it had earlier, which the user may choose to keep, further modify, or delete.

This process of changing Ranks and Attributes can be performed on all new and existing Relationship Credentials in the Availability Schedule.

### Saving Availability Schedules

In an optional embodiment, Availability Schedules are saved in two tables in the system database. The first table contains a record for each Relationship Credential (Group or Friendship) in each Availability Schedule, consisting of the Posting User's ID (userID), the schedule's ID (scheduleID), the schedule's name (set by the Posting User), the schedule's association with a Posted Transaction Proposal, the type of Relationship Credential (Group membership or Friendship), the Relationship Credential's ID (userID of another user for a friendship, or groupID for Group membership) and assigned Rank. The second table contains a record for each Rank in the schedule, consisting of a scheduleID, the Posting User's ID (userID), the Rank and the various Rank Attribute settings including, at a minimum, a reserve period. The Availability Schedules for each user are created by first linking the scheduleID fields in the two tables, then drawing the ranks and rank attribute settings from the second table for the specified scheduleID, then populating each rank with the relationships specified in the first table for that scheduleID and rank.

In another embodiment, Availability Schedules are stored in three tables in the system database. In descending order of scope, these are:
The first table contains a record for each schedule, consisting of the creating user's ID (userID), the schedule's ID (scheduleID), the schedule's name (set by the user) and fields specifying for which types of items the schedule will be used (e.g., “default,” category, subcategory, item title keywords).
The second table contains a record for each Rank in each schedule, consisting of the schedule's ID (scheduleID), the Rank and the various Rank Attribute settings including, at a minimum, a reserve period.
The third table contains a record for each relationship in each schedule, consisting of the schedule's ID (scheduleID), the relationship type (Group membership or Friendship), the relationship's ID (userID for friendships, groupID for memberships) and assigned Rank.

scheduleID is the field which ties these three tables together, which is why userID is only necessary in the first table. scheduleID and Rank tie the second and third tables together and allow the system to group the ranks and relationships together in proper order to create the Availability Schedule.

In one embodiment the system includes a database of Groups to which one or more users may belong and includes the name of each group and identifiers for each of the group members. A group record may be added to the database by any registered user, who will automatically be listed as a member. A registered user can create a group by completing the new group form on the site. This can range to a small private and hidden group limited to the user's closest friends/family, to a visible private group for the user's church/company, to a public group organized around an activity or neighborhood.

There are two ways that other users may join a group. In one embodiment, the Relationship Module 120 includes a list of existing groups that is searchable by all users via the Search and Filter Module 128 and the Relationship Module includes a membership request routine by which a non-member can send a request for membership to the Group's moderator. Upon acceptance of the request, the joining member's ID is added to the Group membership list and the Group ID is added to the joining member's Relationship Credentials. Alternatively, the Group's moderator may send invitations to other users. For this purpose, the system provides, in one embodiment, a search feature by which the user can search for other registered users and, upon finding them, forward invitations to the Group. If the invitee accepts, the Group membership list and the invitee's Relationship Credential list are updated as just described. In an alternative embodiment, the system may permit a user to upload a contacts list and the system may provide a way for the user to extend invitations to people in the contact list.

Similarly, the Relationship Module may include a routine in which a registered user may establish a list of friendships. The user invites other users to enter into a friendship relationship in the same way as he would invite membership in a group. Upon acceptance, the mutual friendship is indicated as a Relationship Credential for both users, and each user may add the other user as a “Friend” to any Rank in an Availability Schedule.

The Search and Filter Module 128 is configured to carry out at least three different basic kinds of searches: (i) searches of a specific user's inventory (a “User Inventory Search”); (ii) searches for items by keyword (an “Item Search”), and (iii) searches for inventories of Groups of which a Viewing User is a member (a “Group Inventory search”). The User Inventory and Group Inventory applications of the invention refer to when the viewing user goes to another user's profile or a group's page and looks at the items available to him from that user or through his association with that group: the items are filtered to show only those items from that user or group that are currently available to the viewing user. The Search and Filter Module 128 processes Viewing User queries and determines which Transaction Proposal Database Entries are made available to a Viewing User according to the Availability Schedule associated with the each Posted Transaction Proposal.

For an Item Search, the Search and Filter Module 128 is configured to accept basic search criteria corresponding to the item description and transaction type that the Viewing User desires and that a Posting User might have entered in a Posted Transaction Proposal. Optionally, the Search module may allow a Viewing User to search by other attributes of a Posted Transaction Proposal, such as a Posting User's geographical location (e.g., the Viewing User may be able to search for Posted Transaction Proposals of Posting Users from a selected country, state, city or ZIP Code). The Search and Filter Module 128 will search the Inventory Database for Posted Transaction Proposals that match the search criteria. Posted Transaction Proposals that match the Viewing User's search criteria are then processed by the Filter module, which checks for the Viewing User's Relationship Credential in the Availability Schedule associated with each matching Posted Transaction Proposal and will report to the Viewing User only those which are available to the Viewing User. In one embodiment the Search and Filter Module 128 looks for the Viewing User's userID among the Friendships, if any, listed in the Availability Schedule and looks for the Viewing User's userID in the listing of Group members of Groups listed in the Availability Schedule to determine the availability of the Posted Transaction Proposal to that Viewing User.

Optionally, when a Posted Transaction Proposal is posted, the system uses the Reserve Periods in the Availability Schedule to generate an availability table to record the dates at which Viewing Users in the various Ranks in the Availability Schedule will have access to the Posted Transaction Proposal. Using the availability table to determine access to a Posted Transaction Proposal is one way of using the Availability Schedule to determine availability.

Optionally, other search functions may be provided to allow a user to search for one or more of 1) Groups: to search for groups that match the entered keywords (so a user can look for groups he may want to join); 2) Users: to search for users that match the userID and/or email address entered by the viewing user; and 3) Help: to search for help entries/FAQs/tutorials related to entered keywords.)

The Transaction Module 130, enables a Viewing User to accept a Transaction Proposal in the Inventory Database and facilitates execution of the transaction. If the Viewing User accepts the transaction proposed in the Posted Transaction Proposal, the system notifies the Posting User. In addition, the Transaction Module 130 may apply a price adjustment or adjust another attribute of the Posted Transaction Proposal in a manner specified for Viewing Users for whom such adjustments are specified according to the Availability Schedule.

For example, once a Viewing User sees a Posted Transaction Proposal that he likes, the Transaction Module 130 which enables him to communicate with the Posting User in connection with that Posted Transaction Proposal, to discuss and optionally conclude the proposed transaction. If the Posting User accepts the Viewing User's offer to transact, the system will guide both users through multiple steps until the item or services is received or performed, at which point both users can mark the transaction as “complete” and leave feedback for each other if desired.

In one embodiment, a Posting User accepts a request to transact from a Viewing User. The system then walks each user through a series of communication steps to assist them in completing the transaction, including allowing the Posting User to confirm acceptance of the transaction request; indicating whether an item has been sent/delivered; and indicating whether an item has been received. For lend/borrow transactions, the transaction communication may include indicating whether an item has been returned and/or whether a returned item has been received. There is also an optional provision for leaving feedback for the transaction partner.

In another optional aspect, the process also allows for transaction steps outside the “normal” back and forth of a successful transaction, including declining a transaction request; canceling a transaction request; modifying a transaction request (before it is accepted by the Posting User); resolving issues with unsuccessful transactions (items lost in shipment, not received or not as described; lent/borrowed items returned damaged).

These and other communications are accomplished by the “message center” module 136 that is built into the system and that processes, stores and displays all messages between site administrators, group moderators and users. All communications between users and administrators, including default messages for the transaction steps detailed above, are stored in the message center. The system allows users to send and retrieve their messages in the site. The system also sends users a daily email summarizing activity in their accounts over the past day. The message center is also configured to facilitate these optional functions: assist users in calculating postage costs for shipped items; add a process to convert postage cost to proprietary user ‘points’ (which provide incentive for further use of the system); links to third-party shipping companies' web sites for shipment pricing and tracking; offering the site's own shipping label/payment system (in partnership with third-party shipping companies); and offering insurance to users who lend items reimbursing them if their items are returned damaged.

The message center may also be enhanced by offering more and more detailed customization of the email notification process. In one embodiment, one daily email is provided to summary of a user's account activity. Users also have the optional ability to specify email notification frequency for different categories of activity in their accounts (e.g., a user could ask for a daily email to summarize account activity, but also immediate notification if a wanted item is posted by another user).

Users would also have the ability to block individual users and the members of specified groups from viewing their available items.

In one embodiment, the system includes a routine to enable a user to create a default block list including the userIDs and groupIDs of all individuals and groups he wants to prohibit from viewing his items and requesting transactions. This may include creating a table in the database with fields for the creating user's userID, relationshipType (to indicate friendship or membership), and relationshipID (the userID of the blocked user or groupID of the blocked group).

In another embodiment, the system includes a routine to enable a user to create multiple, customized block lists based on item type, category, subcategory or keywords in order to prohibit certain users and groups from viewing and transacting in certain subsets of his items. This may include creating two tables in the database: a first table comprised of the creating user's userID, a blocklistID (to distinguish between a user's multiple block lists) and blocklistName (for the user to assign a name to each of his block lists), and a second table which includes blocklistID (to tie to the first table), relationshipType (to indicate friendship or membership) and relationshipID ((the userID of the blocked user or groupID of the blocked group).

In use, the block lists would have the effect of adding another filter layer to a Viewing User's results when looking at another user's available items, a group's available items or keyword item searches. In one embodiment of the current availability schedule system, the system checks whether a Viewing User has a relationship to a Posting User or group, and then, if the relationship exists, displays items from the Posting User or through the group that are available at that point in time. The block list would further filter these results by removing from view any items belonging to Posting Users who have added to their block list(s) the Viewing User or a group of which the Viewing User is a member.

In yet another embodiment, the system is configured to offer customized block lists as enhancements to existing Availability Schedules, so that the resulting Availability Schedule has both an “include” and “exclude” component.

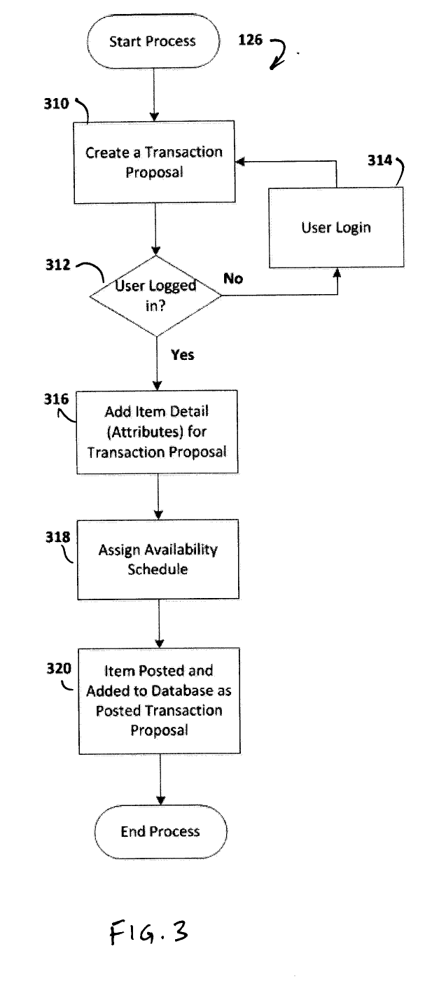

An illustrative example of a use of one embodiment of this invention is now described. First, a Posting User (occasionally referred to herein as “Paul”) will access the System 110 and employ the Users Module 118 to become a registered user and employs the Availability Schedule Module 122 to create at least one Availability Schedule by the process indicated in FIG. 2. He then logs out, but later, as a registered user, Paul decides to add an Item to his inventory and goes to the system's Item Entry Module 126, starting at step 310, FIG. 3, to create a Transaction Proposal. The system checks whether Paul is logged in at step 312. If not, he is redirected to the login page at step 314 and then, after logging in, he is returned to the Item entry page at step 310 to create a Transaction Proposal by entering Item Attributes (e.g., a description of the item and the nature of the proposed transaction) at step 316. Optionally the Item Attributes include a selected predetermined item type or category to be associated with the Transaction Proposal. In step 318 Paul assigns an Availability Schedule to the Transaction Proposal. The Item Entry Module 126 is configured to present Paul with a default relationship schedule (either his default schedule, or another he has created to be associated with a specific Item type, category, subcategory, or other criteria). Paul may accept the default schedule as-is and enter the Item into his inventory, or modify the schedule, or assign a saved Availability Schedule in place of the default. The Transaction Proposal, with the associated Availability Schedule, is then added to Paul's inventory in the Inventory Database (Step 320) as a Posted Transaction Proposal.

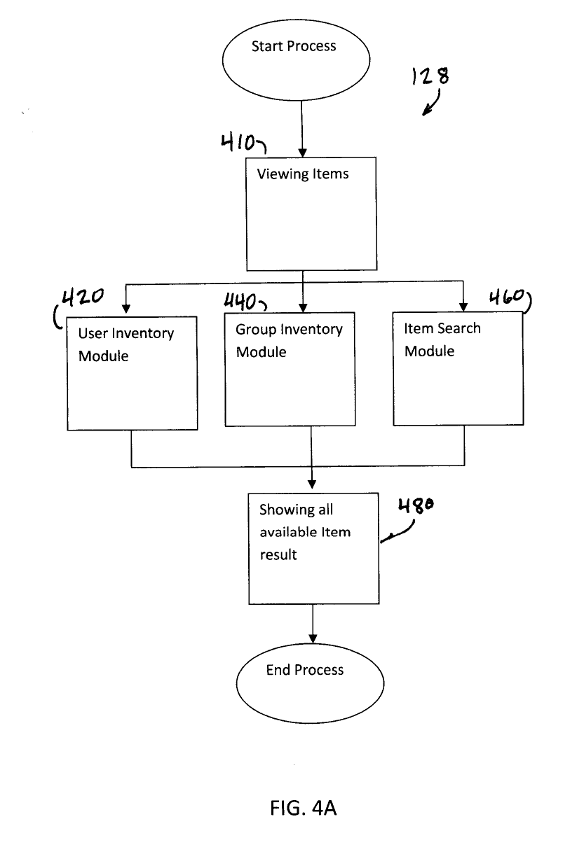

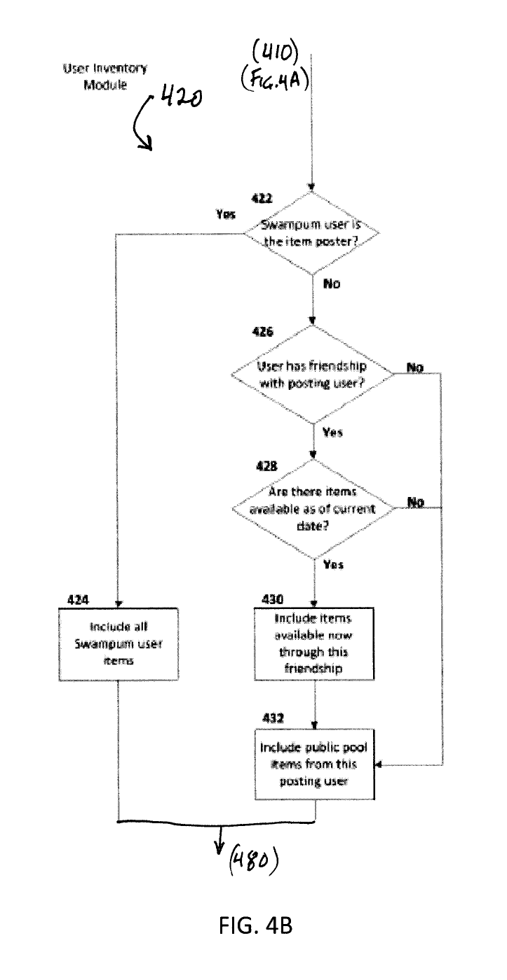

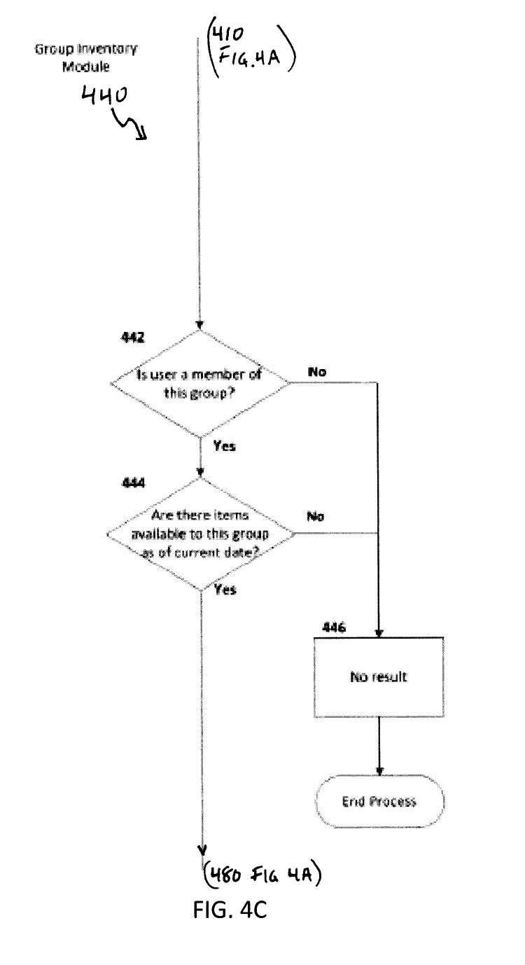

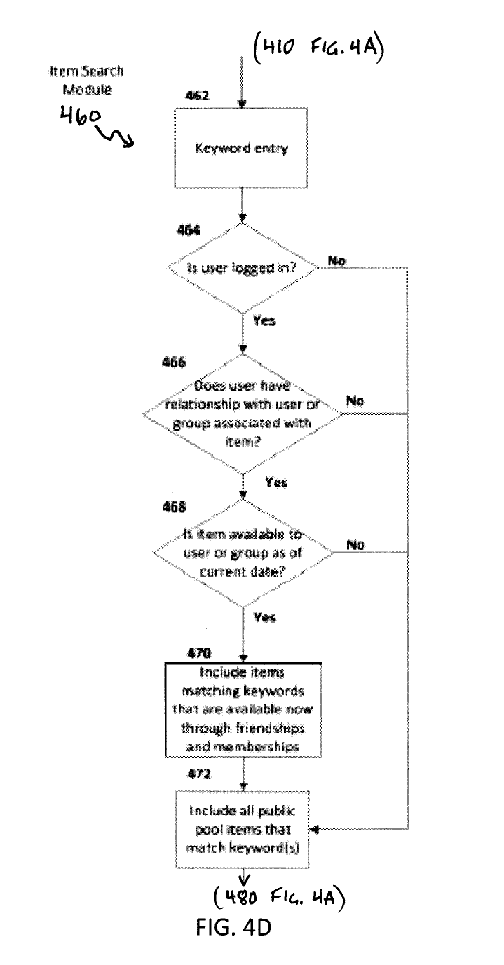

As a Viewing User, Paul may use the system to search for Posted Transaction Proposals in the Inventory Database in the manner indicated in FIG. 4, by accessing the System 110 and employing the Search and Filter Module 128. The Viewing User chooses, from a menu provided by the system, the type of search in Step 410: a User Search 420, a Group Inventory Search 440 or an Item Search 460, to form a Search Query having Query Attributes that correspond to the desired type of search. A Query Attribute may be a keyword for a Posting Attribute such as an Item Attribute for an item of interest to the Viewing User, such as a description of the item, a price range, the userID or other identification of a particular Posting User.

As described with reference to FIG. 4B, if Paul selects a User Search 420 and specifies the user of interest, the system first checks whether he is looking at his own items in step 422. If yes, the system either directs Paul to his own user page and displays all his Posted Transaction Proposal, or in an alternative embodiment searches the Inventory Database and identifies in step 424 all Posted Transaction Proposals that Paul has posted, which are displayed to Paul in step 480.

If Paul is seeking to view Posted Transaction Proposal posted by a another user, the Search and Filter Module 128 determines what relationships Paul has with that user, and the Search and Filter Module 128 proceeds to step 426 to determine, for each Posted Transaction Proposal in the Posting User's Inventory, whether Paul has access to that Posted Transaction Proposal according to the assigned Availability Schedule, in Step 428, which are combined in step 430 with the user's Posted Transaction Proposals that are available to the Public Pool, and together these are displayed to Paul in step 480.

Another search option is to search for Items that are available to a particular Group, initiated at Step 440, described with reference to FIG. 4C, wherein the Search and Filter Module 128 determines if the Viewing User is a member of that Group in step 442. If so, the module identifies the Group Inventory (i.e., determines whether there are Posted Transaction Proposals that are available to the Group) in step 444 and the available Posted Transaction Proposals, if any, are displayed to the Viewing User, in step 480. If in step 442 it is determined that the Viewing User is not a member of the Group in question, the system stops the search in step 446.

Another search option available via the Search and Filter Module 128 is a keyword-based Item Search 460, described in detail with reference to FIG. 4C, which may be initiated at Step 410, which also depends on the posting user's relationship schedule. First, the Viewing User enters keywords in Step 462 into the item search engine, as Query Attributes, and the system checks to see if the Viewing User is logged in, at step 464. If not, the search is limited to those Posted Transaction Proposals having an Item Attribute (the description of the Item) which matches the keywords and that are available to the Public Pool (if any), in step 472, and those are displayed to the Viewing User, in step 480. In an alternative embodiment, a non-logged in Viewing User is denied access to any Posted Transaction Proposals.

However, if the Viewing User is logged in, the system uses his Relationship Credentials to identify Posted Transaction Proposals that are available to him according to the Availability Schedules and that match the search criteria, in steps 468 and 470, and combines those with Posted Transaction Proposals available to the Public Pool, step 472, and displays the combined results at step 480.

When a Posted Transaction Proposal is displayed to a Viewing User, certain terms of the Posted Transaction Proposal may be altered according to the Rank Attributes for that Viewing User's Rank in the Availability Schedule associated with that Posted Transaction Proposal. For example, if the Viewing User is in a Rank that gets a price adjustment, the Viewing User may see a different price than users in other Ranks. Other Rank Attributes may affect other aspects of the Posted Transaction Proposal as well.

When the search results are displayed, Paul may choose to engage the Transaction Module 130 as described above.

### Other Embodiments

In one embodiment, an Availability Schedule may have one Rank (a last Rank) having a Reserve Value, and the system is configured to allow all users to gain access to a Posted Transaction Proposal associated with that Availability Schedule after the Reserve Period has lapsed.

In one embodiment, when a user joins a group, creates a Group, accepts a Friendship or has another user accept a Friendship from him, an associated Relationship Credential is added to that user's Relationship Credentials List and to the User's default Availability Schedule, where the new Relationship Credential is assigned a Rank just above the last Rank in the Availability Schedule (above the Public Pool group). This new Rank is also assigned default Rank Attributes. For example, a user having a default Availability Schedule which contains only a ZIP Code Group with Rank 1 and a Public Pool group at Rank 2 may create a private group that he intends to limit to his closest friends, called “My Friends.” As stated above, a user is automatically a member of any group he creates, so a Relationship Credential of “My Friends” would be added to his Relationship Credential List and to his default Availability Schedule at Rank #2, while the Public Pool would be re-assigned Rank 3 so it remains the last Rank.

Another optional feature of the invention is that the system may be configured to permit a Posting User to assign one or more posting categories to a Posted Transaction Proposal, and to save and store a menu of posting categories for future use. The posting categories may be categories relating to the item or to the type of transaction. An item category may be a type of item, e.g., sporting goods, books, artwork, etc., and the transaction type category may be borrow, lend, sell, purchase, etc. Once the posting categories are stored, one or more posting categories may be associated with one or more Availability Schedules. Then, when the user creates a Posted Transaction Proposal, he will have the option of assigning a posting category to the Posted Transaction Proposal, and having done so, the system will associate with that Posted Transaction Proposal the Availability Schedule previously assigned to that posting category.

In one embodiment, the Inventory Database is searchable by non-Members as well as members, but use of the system for proposing transactions is restricted to system Members (e.g., those who register and/or who pay a user fee). In such case, the system may apply a default Reserve Period to Rank containing the Public Pool to all Availability Schedules to limit availability of Posted Transaction Proposals to Members for a certain period of time before access is granted to non-members, to give Members first choice over non-Members.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention.

What is claimed is:

1. A method for a Posting User to communicate a Transaction Proposal to potential Viewing Users in relation to an Item, the method comprising:
creating an Availability Schedule comprising at least one Rank including a Relationship Credential and a Reserve Value;
creating a Transaction Proposal;
assigning the Availability Schedule to the Transaction Proposal; and
submitting the Transaction Proposal to an Inventory Database in which the a Transaction Proposal is assigned a posting date and becomes a Posted Transaction Proposal, the Inventory Database being searchable by potential Viewing Users having a Relationship Credential that is in the Availability Schedule.

2. The method of claim 1 wherein at least one Relationship Credential is a GroupID.

3. The method of claim 1 wherein the Transaction Proposal is an offer to provide an Item.

4. The method of claim 1 wherein the Transaction Proposal is a request for an Item.

5. The method of claim 1 wherein the Availability Schedule includes a plurality of ordered Ranks.

6. The method of claim 5 wherein the Transaction Proposal includes an Item Attribute, and at least one ante-ultimate Rank includes an Item Attribute Adjustment Factor for modifying an Item Attribute for a Contact.

7. The method of claim 6 wherein the Item Attribute is a price and the Attribute Adjustment Factor includes a Pricing Factor for modifying the Item Price.

8. The method of claim 5 wherein at least one ante-ultimate Rank includes a Relationship Credential is a GroupID.

9. The method of claim 8 wherein the GroupID refers to a Group for which membership is based on the mutual geographic proximity of its members.

10. The method of claim 5 wherein at least one ante-ultimate Rank includes a Relationship Credential is a GroupID of a group formed by the Posting User.

11. A method to facilitate transactions between a Posting User and plurality of Viewing Users, the method comprising:
storing a Posting User's first Availability Schedule, the Availability Schedule comprising at least two ordered Ranks including a last Rank and at least one ante-ultimate Rank which includes a Relationship Credential and an associated Availability Attribute;
receiving from the Posting User a first Transaction Proposal associated with the first Availability Schedule;
adding to an Inventory Database a first Posted Transaction Proposal comprising the first Transaction Proposal and its association with the first Availability Schedule;
receiving a first Search Query from a Viewing User;
searching the Inventory Database for Posted Transaction Proposals having a Posting Attribute that corresponds to the Search Query and to which the Viewing User is permitted access according to the Availability Schedule (“Available Postings”);
displaying the Available Postings to the Viewing User; and
enabling the Viewing User to communicate with the Posting User regarding each Available Posting.

12. The method of claim 11 wherein the Posting Attribute comprises a posting date and the Availability Schedule includes a Reserve Period in relation to a posting date.

13. The method of claim 11 wherein at least one Rank in the Availability Schedule includes an Attribute Adjustment Factor, and the method comprises modifying a displayed Available Posting.

14. The method of claim 13 wherein the Item Attributes include an Item Price and the Attribute Adjustment Factor includes a Pricing Factor for modifying the Item Price.

15. The method of claim 11 wherein a Relationship Credential in at least one Rank indicates membership in a group to which the Posting User belongs or a relationship with the Posting User.

16. The method of claim 11 wherein the Transaction Proposal is an offer to provide an Item.

17. The method of claim 11 wherein the Transaction Proposal is a request for an item.

18. A system for facilitating transactions between Posting Users and Viewing Users, comprising:
first means, for creating at least one Availability Schedule having at least one Rank including a Relationship Credential and a Reserve Value;
second means, for creating a Transaction Proposal;
third means, for assigning the Availability Schedule to the Transaction Proposal; and
fourth means, for submitting the Transaction Proposal to an Inventory Database in which the a Transaction Proposal is assigned a posting date and becomes a Posted Transaction Proposal, wherein the Inventory Database is searchable by potential Viewing Users having a Relationship Credential that is in the Availability Schedule.

19. The system of claim 18 wherein at least one Relationship Credential indicates membership in a Group.

20. The system of claim 18 wherein the Transaction Proposal is an offer to provide an Item.

21. The system of claim 18 wherein the Transaction Proposal is a request for an Item.

22. The system of claim 18 wherein the Availability Schedule includes a plurality of ordered Ranks.

23. The system of claim 22 wherein the Transaction Proposal includes an Item Attribute and at least one Rank other than the last Rank (an “ante-ultimate” Rank) includes an Attribute Adjustment Factor for modifying an Item Attribute for a Contact.

24. The system of claim 23 wherein the Item Attribute is a price and the Attribute Adjustment Factor includes a Pricing Factor for modifying the Item Price.

25. The system of claim 22 wherein at least one ante-ultimate Rank includes a Relationship Credential refers to a Group.

26. The system of claim 25 wherein the Group refers to geographic proximity to the Posting User.

27. The system of claim 22 wherein at least one ante-ultimate Rank includes a Relationship Credential which indicates membership in a group formed by the Posting User.

28. A system for facilitating transactions between Posting Users and Viewing Users, comprising:
first means, for storing a Posting User's first Availability Schedule, the Availability Schedule comprising at least two ordered Ranks including a last Rank and at least one ante-ultimate Rank, wherein at least the ante-ultimate Rank includes a Relationship Credential and an associated Availability Attribute;
second means, for receiving from the Posting User a first Transaction Proposal associated with the first Availability Schedule;
third means, for adding to an Inventory Database a Posted Transaction Proposal comprising the first Transaction Proposal and its association with the first Availability Schedule;
receiving a first Search Query from a Viewing User;
fourth means, for searching the Inventory Database for Posted Transaction Proposals having a Posting Attribute that corresponds to the Search Query and to which the Viewing User is permitted access according to the Availability Schedule (“Available Postings”);
fifth means, for displaying the Available Postings to the Viewing User; and
sixth means for enabling the first Viewing User to communicate with the Posting User regarding each Available Posting.

29. The system of claim 28 wherein the Posting Attribute comprises a posting date and the Availability Schedule includes a Reserve Schedule in relation to a posting date.

30. The system of claim 28 wherein at least one Rank in the Availability Schedule includes an Attribute Adjustment Factor, and the method comprises modifying a displayed Available Posting.

31. The system of claim 30 wherein the Item Attributes include an Item Price and the Attribute Adjustment Factor includes a Pricing Factor for modifying the Item Price.

32. The system of claim 28 wherein a Relationship Credential in at least one Rank indicates membership in a group to which the Posting User belongs or a relationship with the Posting User.

33. The system of claim 28 wherein the Transaction Proposal is an offer to provide an Item.

34. The system of claim 28 wherein the Transaction Proposal is a request for an item.
